(19) United States
(12) Patent Application Publication
(10) Pub. No.: US 2011/0020611 A1
(43) Pub. Date: Jan. 27, 2011

(54) Single-curved glass sheet manufacturing system

(75) Inventors: Kenshu Ando, Tokyo (JP); Toshiya Funahashi, Tokyo (JP); Kyoichi Fujihara, Tokyo (JP)

Correspondence Address: BRUCE L. ADAMS, ESQ;ADAMS & WILKS, SUITE 1231, 17 BATTERY PLACE, NEW YORK, NY, 10004, US

(73) Assignee: NIPPON SHEET GLASS COMPANY, LIMITED

(21) Appl. No.: 12/804,504

(22) Filed: Jul. 22, 2010

(30) Foreign Application Priority Data
Jul. 24, 2009 (JP) 2009-173622

(51) Int. Cl. B60J 1/17; C03B 23/023; C03B 23/02

(52) U.S. Cl. 428/174; 65/106; 65/289

(57) ABSTRACT

An apparatus for manufacturing a single-curved glass sheet with little difference between the radius of curvature of a front end portion and the radius of curvature of a rear end portion of the glass sheet. The apparatus includes a heating furnace and a cooling device. The cooling device is provided with a plurality of upper nozzles for spraying cooling air onto an upper surface of heated/molded curved glass sheet. The upper nozzles are moved by movement means parallel to a path of travel of the glass sheet.

### FIELD OF THE INVENTION

The present invention relates to a technique for manufacturing a single-curved glass sheet used in, e.g., an automobile.

### BACKGROUND OF THE INVENTION

An automobile window glass sheet, for example, uses a single-curved glass sheet that is arcuately curved in cross section in similar fashion to a cylindrical body being divided along the lengthwise direction. A single-curved glass sheet manufacturing apparatus is disclosed in, e.g., Japanese Patent Application Laid-Open Publication No. HEI 10-287438 (JP-A H10-287438).

FIG. 10 hereof illustrates the single-curved glass sheet manufacturing apparatus disclosed in JP-A H10-287438.

Referring to FIG. 10, the single-curved glass sheet manufacturing apparatus 100 includes a heating furnace 103 for heating a glass sheet 102 on a heating bed 101 and causing the glass sheet 102 to transform to an arbitrary shape; and a cooler 104 for cooling the glass sheet 102 which has been heated and molded in the heating furnace 103, the cooler being arranged downstream from the heating furnace 103.

A single-curved glass sheet manufactured by such a manufacturing apparatus 100 has been found to have a problem such as that illustrated in FIG. 11.

The present inventors measured the radius of curvature R1 of the front end portion of the single-curved glass sheet 106 and the radius of curvature R2 of the rear end portion, and it is apparent that the radius of curvature R1 (e.g., 2109 mm) and the radius of curvature R2 (e.g., 1920 mm) are not the same and that there is a difference between the radius of curvature R1 and the radius of curvature R2, as shown in FIG. 11.

When the difference between the radius of curvature R1 and the radius of curvature R2 exceeds 50 mm, the single-curved glass sheet 106 is inadequately assembled into a vehicle body. Additionally, when the difference between the radius of curvature R1 and the radius of curvature R2 is considerable, an image reflected onto the single-curved glass sheet 106 appears distorted and the external appearance deteriorates.

The difference between the radius of curvature R1 and the radius of curvature R2 is conspicuous with a glass sheet that exceeds 800 mm in length.

In view of this fact, the present inventors carried out an experiment to investigate the cause of the difference in the radius of curvature R1 and the radius of curvature R2.

The method of experimentation is illustrated in FIG. 12.

The temperature of the glass sheet 102 transported from the heating furnace 103 (FIG. 10) and cooled in the cooler 104 was measured, as shown in FIG. 12. The temperature was measured in four locations: the front end upper surface T1, the front end lower surface T2, the rear end upper surface T3, and the rear end lower surface T4.

The temperature variation at this time is illustrated in FIG. 13.

FIG. 13 is a temperature curve diagram of the glass sheet with time plotted along the horizontal axis and the temperature plotted along the vertical axis. The reference numeral T0 is a strain point shown by the imaginary line in the center. The strain point is the temperature and below at which strain does not occur no matter how rapidly glass sheet is cooled.

For the front end upper surface T1, cooling starts at P1 and ends at P2. Rapid cooling takes place between P1 and P2 and the temperature passes through the strain point T0 during this interval.

For the front end lower surface T2, cooling starts at P1 and ends at P2. Rapid cooling takes place between P1 and P2 and the temperature passes through the strain point T0 during this interval.

For the rear end upper surface T3, the temperature gradually decreases from P3, rapid cooling starts at P4, and cooling ends at P5. The rear end upper surface T3 is rapidly cooled from P4 to P5 and the temperature passes through the strain point T0 during this interval.

For the rear end lower surface T4, cooling starts at P6 and ends at P7. Rapid cooling takes place between P6 and P7 and the temperature passes through the strain point T0 during this interval.

The timing for [the temperature] to arrive at the strain point T0 is substantially the same for the front end upper surface T1 and the front end lower surface T2. However, the rear end lower surface T4 is still at a temperature that is higher than the strain point T0 when the temperature of the rear end upper surface T3 arrives at the strain point T0 (P8). Hence, the temperature of the rear end lower surface T4 arrives at the strain point T0 at P9, which is later than for the rear end upper surface T3.

The rear end has a difference in timing of arrival at the strain point T0 in terms of the temperature of the rear end upper surface T3 and the rear end lower surface T4. At the temperature of the strain point T0 or lower, the strain caused by temperature difference is not further alleviated. Therefore, thermal contractions appear as shape deformations caused by the temperature difference when there is a timing difference for arriving at the strain point T0. It is presumed that the difference in timing for the temperature to arrive at the strain point T0 is caused by the difference in the radii of curvature R1, R2 (FIG. 11).

Specifically, if the temperature of the rear end upper surface T3 and the rear end lower surface T4 were to reach the strain point T0 with substantially the same timing, it is presumed that there would be no difference in the radius of curvature of the front end portion and the radius of curvature of the rear end portion.

Next, FIG. 14 illustrates the cause of the temperature of T3 to gradually decrease in the interval from P3 to P4 prior to the start of cooling.

When the front end upper and lower surfaces T1, T2 of the glass sheet 102 arrive at the cooler 104, as shown in FIG. 14, cooling air flows from the front end upper surface T1 toward the rear end upper surface T3 across the upper surface of the glass sheet 102, as indicated by the arrow. The rear end upper surface T3 is indirectly cooled by this cooling air and the temperature gradually decreases until the rear end upper surface arrives at the cooler 104.

FIGS. 10 to 14 can be described in the following manner.

The rear end upper surface T3 decreases in temperature until the rear end upper surface arrives at the cooler 104. The temperature is reduced, resulting in a difference in timing in which the temperature of the rear end upper surface T3 and the rear end lower surface T4 reach the strain point T0 (see FIG. 13). On the other hand, the temperature of the front end upper surface T1 and the front end lower surface T2 reach the strain point T0 with substantially the same timing. A difference in the radii of curvature is produced between the front end, which does not experience a difference in timing of reaching at the strain point T0, and the rear end, which does experience a difference in timing of reaching at the strain point T0 (see FIG. 11). When the difference in the radii of curvature is considerable, problems arise in the assembly characteristics and the external appearance.

### SUMMARY OF THE INVENTION

It is therefore an object of the present invention to provide a technique for manufacturing a single-curved glass sheet with little difference between the radius of curvature of the front end portion of the glass sheet and the radius of curvature of the rear end portion of the glass sheet.

According to one aspect of the present invention, there is provided a single-curved glass sheet manufacturing apparatus which comprises: a heating furnace for heating a glass sheet on a heating bed therein to transform the glass sheet into an arbitrary shape; and a cooling device, provided adjacent to the heating furnace, for cooling the glass sheet by bringing cooling air into contact with the glass sheet transformed in the heating furnace, wherein the cooling device comprises: a plurality of lower nozzles for spraying the cooling air onto a lower surface of the glass sheet; glass sheet position detection means, disposed above the lower nozzles, for detecting a position of the glass sheet; a plurality of upper nozzles, disposed above the glass sheet position detection means, for spraying cooling air onto an upper surface of the glass sheet; and movement means, connected to the upper nozzles, for moving the upper nozzles parallel to a direction of movement of the glass sheet.

In the thus-arranged glass sheet manufacturing apparatus, with the movement means provided for moving the upper nozzles in the direction of movement of the glass sheet, when the rear end of the glass sheet is transported into the cooling device, the upper nozzles are moved in the forward movement direction of the glass sheet. The cooling air does not make contact with the rear end upper surface while the cooling air makes contact with the rear end lower surface. The rear end lower surface is rapidly cooled and the cooling air also makes direct contact with the rear end upper surface at a timing where the rear end lower surface reaches the same temperature as the rear end upper surface. The temperatures of the rear end upper surface and the rear end lower surface thereby reach the strain point in substantially the same amount of time. Since the temperatures of front end upper surface and the front end lower surface already reach the strain point at substantially the same timing, the difference in the radius of curvature of the front end portion of the glass sheet and the radius of curvature of the rear end portion is reduced.

According to a second aspect of the present invention, there is provided a single-curved glass sheet manufacturing apparatus which comprises: a heating furnace for heating a glass sheet on a heating bed thereof to transform the glass sheet into an arbitrary shape; and a cooling device, provided adjacent to the heating furnace, for cooling the glass sheet by bringing cooling air into contact with the glass sheet transformed in the heating furnace, wherein the cooling device comprises: a plurality of lower nozzles for blowing the cooling air onto a lower surface of the glass sheet; glass sheet position detection means, disposed above the lower nozzles, for detecting a position of the glass sheet; an upper wind box, provided above the glass sheet position detection means, for reserving cooling air; a plurality of swing nozzles provided to the upper wind box in such a manner as to be swingable in a direction of movement of the glass sheet; and a controller for switching directions of delivery of the cooling air by causing the swing nozzles to swing in the direction of movement of the glass sheet.

In the thus-arranged glass sheet manufacturing apparatus, the swing nozzles swing in the direction of forward movement of the glass sheet when the rear end upper and lower surfaces of the glass sheet are transported into the cooling mechanism. The cooling air does not make contact with the rear end upper surface while the cooling air makes contact with the rear end lower surface. The rear end lower surface is rapidly cooled and the cooling air also makes direct contact with the rear end upper surface at a timing where the rear end lower surface reaches the same temperature as the rear end upper surface. The temperatures of the rear end upper surface and the rear end lower surface thereby reach the strain point at substantially the same timing. Since the temperatures of front end upper surface and the front end lower surface already reach the strain point at substantially the same timing, the difference in the radius of curvature of the front end portion of the glass sheet and the radius of curvature of the rear end portion is reduced.

According to a third aspect of the present invention, there is provided a single-curved glass sheet manufacturing method comprising the steps of heat-shaping a glass sheet into a predetermined single-curved shape; and cooling the heat-shaped glass sheet by applying cooling air thereto, wherein the cooling step comprises causing the glass sheet to continuously move forward along a path of movement within a cooling device; cooling a front end upper surface and a front end lower surface of the glass sheet simultaneously; then, cooling a rear end lower surface of the glass sheet; and a predetermined time thereafter, cooling a rear end upper surface of the glass sheet.

The manufacturing method starts cooling of the rear end upper surface after a predetermined time has elapsed from the start of cooling of the rear end lower surface. The rear end lower surface is rapidly cooled and the cooling air also makes direct contact with the rear end upper surface with a timing in which the rear end lower surface reaches the same temperature as the rear end upper surface. The temperatures of the rear end upper surface and the rear end lower surface thereby reach the strain point at substantially the same timing. Since the temperatures of the front end upper surface and the front end lower surface already reach the strain point at substantially the same timing, the difference in the radius of curvature of the front end portion of the glass sheet and the radius of curvature of the rear end portion is reduced.

According to a fourth aspect of the present invention, there is provided a single-curved glass sheet manufactured by a single-curved glass sheet manufacturing method which comprises the steps of heat-shaping a glass sheet into a predetermined single-curved shape; and cooling the heat-shaped glass sheet by applying cooling air thereto, the cooling step comprising: causing the glass sheet to continuously move forward along a path of movement within a cooling device; cooling a front end upper surface and a front end lower surface of the glass sheet simultaneously; then, cooling a rear end lower surface of the glass sheet; and a predetermined time thereafter, cooling a rear end upper surface of the glass sheet, wherein the single-curved glass sheet has a front end part of a first radius of curvature and a rear end part of a second radius of curvature, a difference between the first radius of curvature and the second radius of curvature being set to be 50 mm or less, and the glass sheet also has a length along the path of movement, which is set to be 800 mm or more.

When the length of the single-curved glass sheet is 800 mm or more in a longitudinal direction thereof, the rear end upper surface of the glass sheet is cooled considerably before being transported into the cooling device. Accordingly, such a large glass sheet readily experiences a temperature difference between the rear end upper surface and the rear end lower surface during transport into the cooling device. On the other hand, a large glass sheet having a length of 800 mm or more in its longitudinal direction is used in locations in which importance is placed on external appearance. Specifically, the external appearance of glass sheet requiring particularly aesthetic appearance can be improved.

### BRIEF DESCRIPTION OF THE DRAWINGS

Certain preferred embodiments of the present invention will be described in detail below, by way of example only, with reference to the accompanying drawings, in which:

FIG. 1 is a schematic view illustrating a single-curved glass sheet manufacturing apparatus according to a first embodiment of the present invention;

FIG. 2 is a schematic view illustrating an operation of a cooling device shown in FIG. 1;

FIG. 3 is a graph showing temperature variations on a surface of a glass sheet upon cooling of the latter;

FIG. 4 is a schematic view illustrating a method for determining a length of movement of upper nozzles;

FIG. 5 is a schematic view showing a radius of curvature of a front end portion and a radius of curvature of a rear end portion of the curved glass sheet;

FIG. 6 is a schematic view showing correction of the movement length of the upper nozzles;

FIG. 7 is a schematic view illustrating control of the movement of the upper nozzles upon cooling of the curved glass sheet;

FIG. 8 is a flowchart showing a method of use of the single-curved glass sheet manufacturing apparatus;

FIG. 9 is a schematic view illustrating a cooling device with swingable upper nozzles, according to a second embodiment of the present invention;

FIG. 10 is a view illustrating a conventional curved glass sheet manufacturing apparatus;

FIG. 11 is a view showing a conventional curved glass sheet;

FIG. 12 is a schematic view illustrating a conventional curved-glass cooling device experimented to investigate the cause of a problem therein;

FIG. 13 is a graph showing temperature variation of the curved glass sheet upon cooling of the glass sheet using the cooling device of FIG. 12; and

FIG. 14 is a schematic view showing the cause of the temperature variation of FIG. 13.

### DETAILED DESCRIPTION OF THE PREFERRED EMBODIMENTS

### Embodiment 1

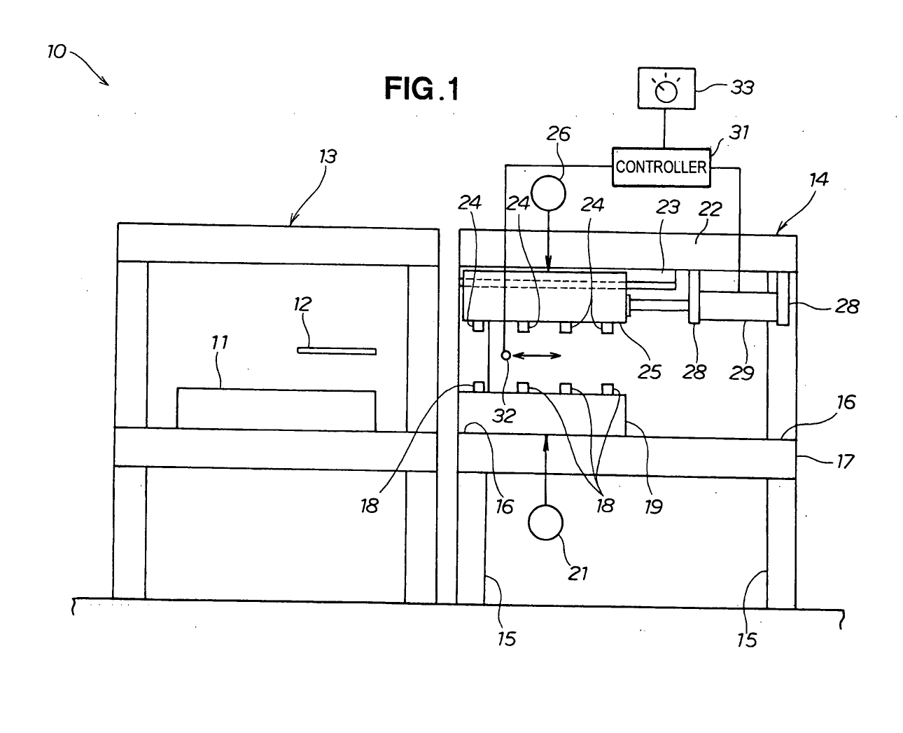

A single-curved glass sheet manufacturing apparatus 10 has a heating furnace 13 for heating a glass sheet 12 in a heating bed 11 and transforming the glass sheet 12 into an arbitrary shape; and a cooling device 14 for cooling the glass sheet 12 by bringing cooling air into contact with the heated/molded glass sheet 12, the cooling device being arranged adjacent to and downstream from the heating furnace 13, as shown in FIG. 1.

The cooling device 14 includes a base unit 17 supported by legs 15, 15, the base unit having apertures 16, 16 that constitute a transport inlet and a transport outlet for the glass sheet 12. A plurality of lower nozzles 18 for spraying cooling air onto the lower surface of the glass sheet 12 is arranged on the base unit 17. A lower wind box 19 for reserving cooling air to be delivered to the plurality of lower nozzles 18 supports the plurality of lower nozzles 18. A lower blower 21 for delivering cooling air into the lower wind box 19 is connected to the lower wind box 19. A guide member 23 is supported on the lower surface of a top plate 22 of the base unit 17. A plurality of upper nozzles 24 for spraying cooling air toward the upper surface of the glass sheet 12 is moveably supported by the guide member 23. An upper wind box 25 for reserving cooling air to be delivered to the plurality of upper nozzles 24 supports the plurality of upper nozzles 24. An upper blower 26 for feeding cooling air to the upper wind box 25 is connected to the upper wind box 25.

Movement means 29 is supported via flanges 28, 28 on the lower surface of the top plate of the base unit 17. The movement means 29 moves the upper nozzles 24 together with the upper wind box 25 in the crosswise direction in the diagram. A controller 31 controls the operation of the movement means 29. Glass sheet position detection means 32 is provided so as to be capable of movement in the crosswise direction of the diagram, and sends detection signals to the controller 31. A dial 33 transmits as a signal to the controller 31 the incoming type of the glass sheet 12. When the type of the glass sheet 12 is changed, an operator turns the dial 33 in accordance with the type of the glass sheet 12. The controller 31 recognizes that the type of the glass sheet 12 has been changed, and changes the position in which the glass sheet position detection means 32 is arranged.

The glass sheet 12 is floated by the force of air in the heating furnace 13 and is moved from left to right in the diagram. Specifically, floatation transport means (not shown) is used for moving the glass sheet 12. The same applies to the cooling device 14 as well.

Cylinders for oil pressure, water pressure, air pressure can be used as the movement means 29.

A so-called linear guide may be used as the guide member 23.

A blower or fan may be used as the lower blower 21. The same applies to the upper blower 26 as well.

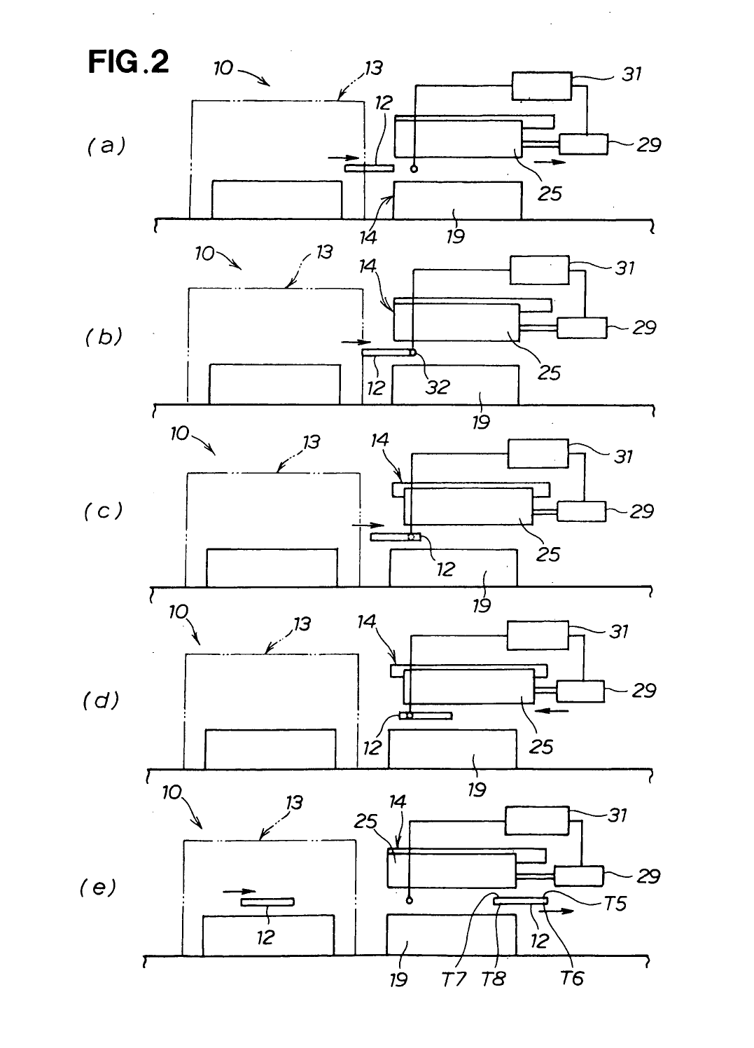

The operation of such a single-curved glass sheet manufacturing apparatus 10 will be described with reference to FIGS. 2(a) through (e).

The glass sheet 12 is convexly curved in similar fashion to a cylindrical body being divided along the lengthwise direction, while being heated in the heating furnace 13, and is then transported to the cooling device 14, as shown in FIG. 2(a).

The glass sheet 12 transported to the cooling device 14 is transported to a location in which the glass sheet position detection means 32 is arranged, as shown in FIG. 2(b). The glass sheet position detection means 32 sends to the controller 31 a detection signal indicating that the glass sheet 12 has arrived at a predetermined position, and the controller 31 actuates the movement means 29. The upper wind box 25 is moved to the right in the diagram when the movement means 29 is actuated.

When a predetermined time has elapsed after the controller 31 has actuated the movement means 29, the controller 31 stops the movement means 29, as shown in FIG. 2(c), and stops the movement of the upper wind box 25. At this point, the glass sheet 12 is continuously transported regardless of the action of the upper wind box 25.

When a predetermined time has elapsed after the movement of the upper wind box 25 has stopped, the rear end of the glass sheet 12 completely enters the upper wind box 25. The controller 31 thereafter actuates the movement means 29 and moves the upper wind box 25 to the left in the diagram, as shown in FIG. 2(d).

The single-curved glass sheet is sufficiently cooled in the cooling device 14 and thereby completed, as shown in FIG. 2(e). A new glass sheet 12 is then transported into the heating furnace 13.

Here, T5 is the front end upper surface of the glass sheet 12, T6 is the front end lower surface of the glass sheet 12, T7 is the rear end upper surface of the glass sheet 12, and T8 is rear end lower surface of the glass sheet 12.

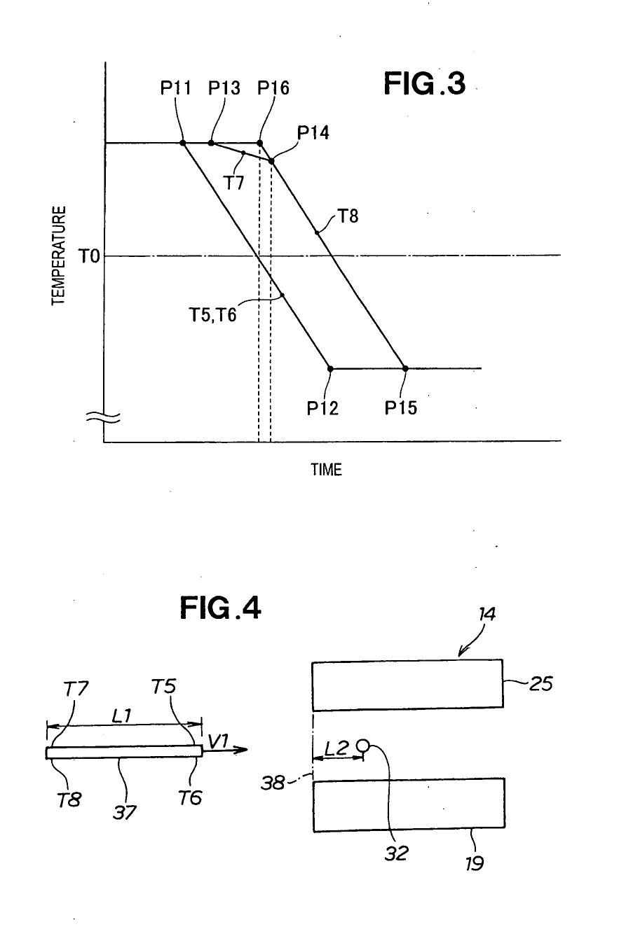

The temperature variations of T5 to T8 in FIGS. 2(a) to (e) will be described with reference to FIG. 3. In FIG. 3, time is plotted along the horizontal axis and temperature is plotted along the vertical axis. The reference numeral T0 indicated by the imaginary line in the center is the strain point.

Cooling of the front end upper surface T5 of the glass sheet discharged from the heating furnace begins at P11 and cooling ends at P12, as shown in FIG. 3. The glass sheet is rapidly cooled between P11 and P12 and the temperature passes through the strain point T0 during this interval.

Cooling of the front end lower surface T6 also begins at P11 and cooling ends at P12. The glass sheet is rapidly cooled between P11 and P12, and the temperature passes through the strain point T0 during this interval.

The front end upper surface T5 and the front end lower surface T6 undergo substantially the same temperature change and arrive at the strain point T0 with substantially the same timing.

The temperature of the rear end upper surface T7 begins to gradually decrease at P13, rapid cooling begins at P14, and cooling ends at P15. The glass sheet is rapidly cooled between P14 and P15, and the temperature passes through the strain point T0 during this interval.

Cooling of the rear end lower surface T8 begins at P16, and cooling ends at P15. The glass sheet is rapidly cooled between P16 and P15, and the temperature passes through the strain point T0 during this interval.

The rear end lower surface T8 is cooled beginning at P16, and the rear end upper surface T7 is cooled beginning at P14. The temperature of the rear end upper surface T7 is lower than that of the rear end lower surface T8 at the time point P16. From P16 to P14, the rear end lower surface T8 is rapidly cooled and the temperature of the rear end upper surface T7 is gradually reduced. The temperature of the rear end upper surface T7 and the temperature of the rear end lower surface T8 at P14 are therefore the same.

The rear end upper surface T7 also begins to cool when the temperatures have become the same. Accordingly, the temperature change of the rear end upper surface T7 from P14 to P15 and the temperature change of the rear end lower surface T8 are substantially the same. The temperatures of the rear end upper surface T7 and the rear end lower surface T8 pass through the strain point T0 at substantially the same time in the interval from P14 to P15.

The technique for manufacturing a single-curved glass sheet in accordance with the present invention can be described in the following manner with reference to FIGS. 2 and 3.

The upper wind box 25 is moved in advance in the forward direction of the glass sheet 12 when the rear end of the glass sheet 12 is transported into the cooling device 14. Cooling air is brought into contact with the rear end lower surface T8 of the glass sheet 12, and cooling air is not brought into contact with the rear end upper surface T7 of the glass sheet 12. However, the cooling air flows rearward along the upper surface of the glass sheet 12, and though this does not constitute direct cooling, the rear end upper surface T7 is therefore gradually cooled.

Next, the rear end lower surface T8 is rapidly cooled from the front end of the glass sheet 12, and the cooling air is directly brought into contact with the rear end upper surface T7 with a timing in which the rear end lower surface T8 reaches the same temperature as the rear end upper surface T7. The temperatures of the rear end upper surface T7 and the rear end lower surface T8 reach the strain point T0 at substantially the same timing. Since the temperatures of front end upper surface T5 and the front end lower surface T6 already reach the strain point T0 at substantially the same timing, the difference in the radius of curvature of the front end of the glass sheet and the radius of curvature of the rear end is reduced.

The single-curved glass sheet manufacturing apparatus 10 of the present invention is particularly useful in manufacturing the glass sheet 12 having length of 800 mm or more in the lengthwise direction. The rear end upper surface T7 is gradually cooled until being transported into the cooling device 14, as described above, because the length is 800 mm or more in the lengthwise direction. When transported into the cooling device 14, a large glass sheet 12 of such description readily experiences a temperature difference with the rear end lower surface T8. On the other hand, the large glass sheet having a length of 800 mm or more in the lengthwise direction is used in locations in which external appearance is particularly noticeable, and is used in locations where there is a particular need for esthetic appearance.

The rear end upper surface T7 begins to be directly cooled by the upper nozzles 24 (FIG. 1) at the point at which the temperature of the rear end lower surface T8 is reduced to the same temperature as the temperature of the rear end upper surface T7. The timing at which the rear end upper surface T7 begins to cool must be determined in advance depending on the type of the glass sheet.

Ordinarily, the speed at which the glass sheet travels is constant. Therefore, the rate at which the upper wind box 25 moves is adjusted so that the timing at which the rear end upper surface T7 begins to cool can be adjusted. The method for determining the timing at which the rear end upper surface T7 begins to cool is illustrated in FIGS. 4 through 6.

A glass sheet 37 heated and molded in the heating furnace 13 (FIG. 1) is transported to the cooling device 14 in the same manner as the step for manufacturing an ordinary single-curved glass sheet, as shown in FIG. 4. At this point the wipe member 37 is transported at a transport speed V1. Initially, the upper wind box 25 is not moved even when the glass sheet 37 arrives at the glass sheet position detection means 32.

L1 is the length of the glass sheet 37 (e.g., L1=800 mm), L2 is the length from the rear end position 38 of the lower wind box 19 to the glass sheet position detection means 32 (e.g., L2=(½)L1=400 mm), and V1 is the transport speed of the glass sheet 37 (e.g., V1=0.1 m/s).

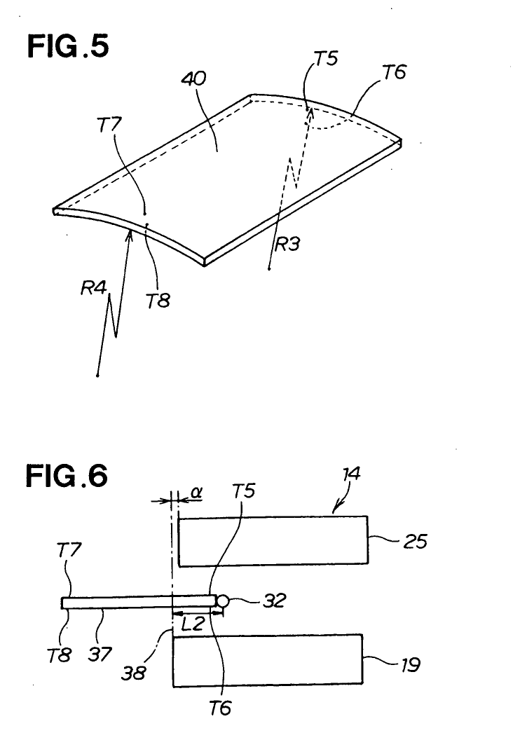

The length L2 from the rear end position 38 of the lower wind box 19 to the glass sheet position detection means 32 can be an arbitrary value selected from (⅓)L1 to (⅔)L1. The single-curved glass sheet manufactured in this manner is measured. The measurement method is illustrated in FIG. 5.

The radius of curvature R3 of the front end of the single-curved glass sheet 40 and the radius of curvature R4 of the rear end are measured, as shown in FIG. 5. For example, a three-dimensional measuring instrument can be used for measurement.

At this point, the value of (R3−R4) is within acceptable limits if equal to or less than 30 mm, and outside acceptable limits if greater than 30 mm. Here, the reason that (R3−R4) is within acceptable limits if less than or equal to 30 mm is because individual differences that are produced in the manufacturing process are taken into account. In other words, by making it acceptable for (R3−R4) to be less than or equal to 30 mm, (R3−R4) 50 mm will also be fulfilled for the single-curved glass sheet 40, which is preferred as the final product.

If the measurements reveal the value to be outside the acceptable limit, the timing for starting the cooling of the rear end upper surface T7 must be delayed. The method for delaying the timing of the start of cooling is illustrated in FIG. 6.

The upper wind box 25 is moved by a distance α (e.g., 5 mm) when the glass sheet position detection means 32 has detected the glass sheet 37, as shown in FIG. 6. The single-curved glass sheet 40 (FIG. 5) thus fabricated is assessed once more against the acceptance/failure criteria.

In other words, (R3−R4)≦30 mm is tested. If successful, the movement distance of the upper wind box 25 is set to α. On the other hand, if unsuccessful, the movement distance α of the upper wind box 25 shown in FIG. 6 is set to 2×α, and a single-curved glass sheet is manufactured again.

The movement distance of the upper wind box 25 is changed to 3×α and 4×α until (R3−R4)≦30 mm. For example, (R3−R4) is 13 mm when R3=2155 mm and R4=2142 mm, and the movement distance n×α of the upper wind box 25 was found by experimentation to be 35 mm. Since the transport speed V1 of the glass sheet 12 is constant, the timing at which the cooling of the rear end upper surface T7 of the glass sheet 12 is determined ((n×α)/V1) by determining the movement distance n×α.

It is also possible that the point at which (R3−R4)≦30 mm cannot be found even when the movement distance is varied. In this case, the spray intensity of the nozzles 18, 24 (FIG. 1) is varied, and another search is made for the movement distance n×α at which the (R3−R4)≦30 mm by using the varied spray intensity. It is also possible to modify the transport speed V1 of the glass sheet.

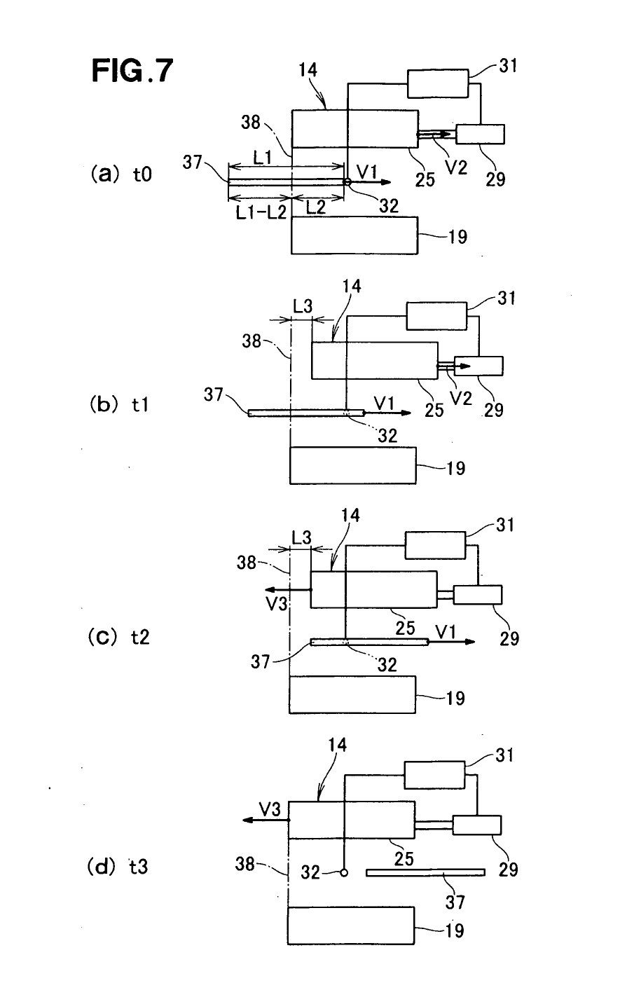

The timing for starting the cooling of the rear end upper surface T7 obtained in this manner is inputted to the controller 31 (FIG. 1). In the case that the spray intensity or other parameter of the cooling air is varied in accordance with the type of glass sheet, this information is also inputted to the controller. The information inputted to the controller will also be described in detail with reference to FIGS. 7(a) to (d).

The arrival of the glass sheet 37 at the glass sheet position detection means 32 is transmitted to the controller 31, as shown in FIG. 7(a). The controller 31 actuates the movement means 29 and starts a timer housed in the controller 31. The actuating of the movement means 29 causes the upper wind box 25 to move. The time at which the glass sheet 37 arrives at the glass sheet position detection means 32 is set as a reference time t0.

As shown in FIG. 7(b), the upper wind box 25 is moved a movement distance L3 (=n×α) determined in FIGS. 4 to 6. Since the operational speed of the movement means 29 in the rightward direction of the diagram is V2, the movement means 29 can be operated for t1=L3/V2 (seconds). Specifically, the controller 31 stops the movement means 29 t1 seconds after t0.

Next, the upper wind box 25 is returned to its original position when, e.g., the rear end of the glass sheet 37 and the rear end of the upper wind box 25 overlap, as shown in FIG. 7(c). At this point, t2 seconds elapse after t0. During this interval of t2 seconds, the glass sheet 12 advances (L1−L2+L3) at the transport speed V1 from the position indicated in FIG. 7(a). Therefore, t2=(L1−L2+L3)/V1 (seconds).

When the upper wind box 25 is moved leftward in the diagram by a distance L3, the upper wind box 25 is returned to its original position, as shown in FIG. 7(d). Since the movement speed of the upper wind box 25 is V3 during return, the controller 31 stops the movement of the upper wind box 25 L3/V3 seconds after t2 (FIG. 7(c)). When the stoppage is set to t3 seconds after t0, t3=t2+(L3/V3) (seconds). When the upper wind box 25 has returned to its original position, the controller 31 resets the internally housed timer.

L1 to L3 vary depending on the size, shape, and thickness of the glass sheet 12. Accordingly, t1 to t3 set by L1 to L3 must also be varied depending on the type of glass sheet 12. The times t1 to t3 are inputted in advance to the controller 31 for each type of glass sheet 12.

The method for using the single-curved glass sheet manufacturing apparatus 10 (FIG. 1) into which the information of a plurality of types of glass sheet 12 has been inputted will be described with reference to the next diagram.

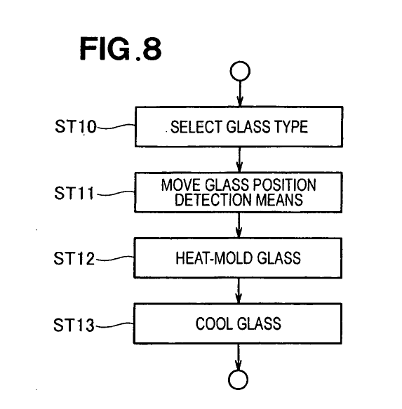

First, in step (“ST”) 10, the operator sets the dial 33 (FIG. 1) to the type of the glass sheet that is to be transported, as shown in FIG. 8.

Next, the controller moves the glass sheet position detection means to a predetermined position in accordance with the predetermined type of the glass sheet (ST11).

When movement has ended, the glass sheet is heated and molded (ST12) by being transported into the heating furnace. The glass sheet thus heated and molded is transported into the glass sheet cooling device and cooled (ST13), and the single-curved glass sheet is completed.

In lieu of the operator operating a dial, it is also possible to provide a sensor upstream of the heating furnace and to use the sensor to identify the type of glass sheet to be transported.

### Embodiment 2

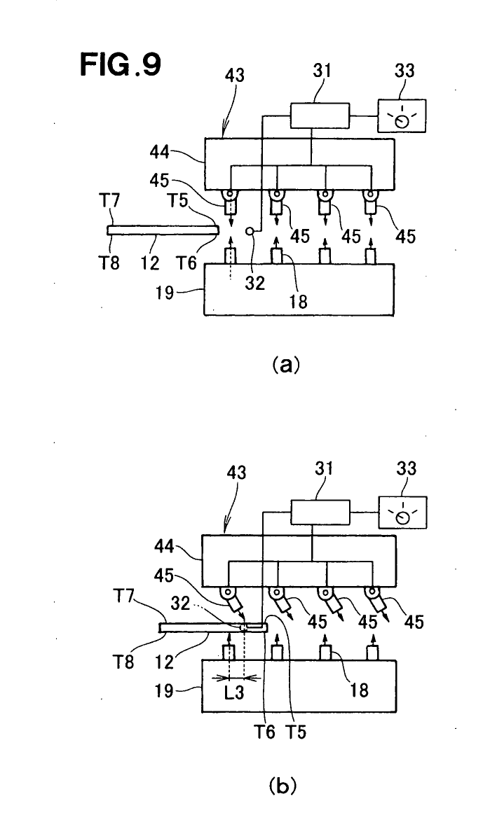

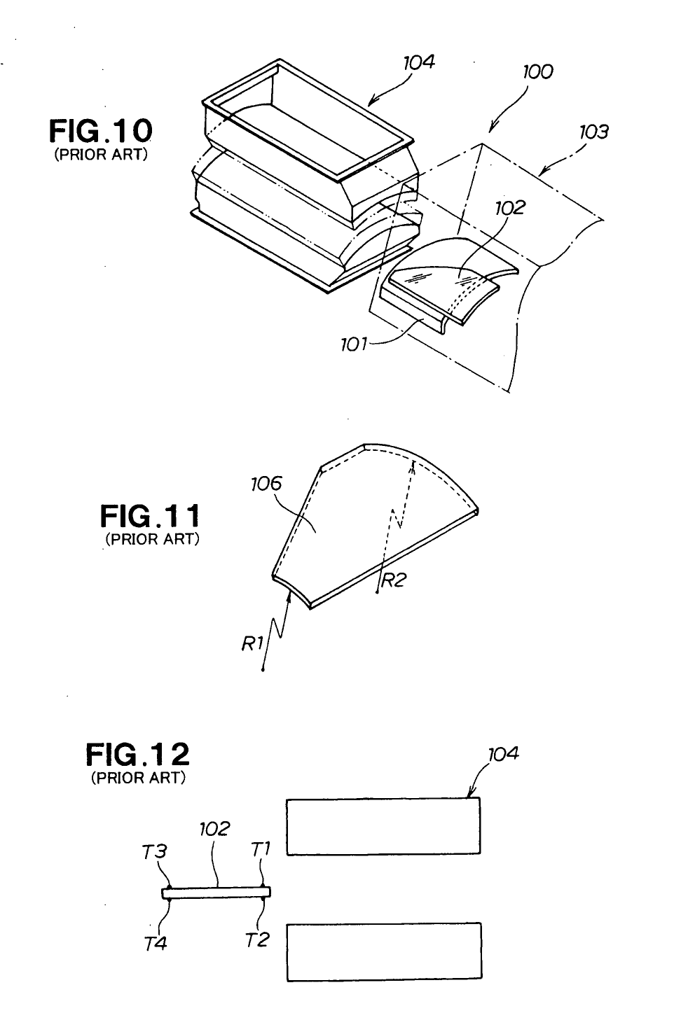

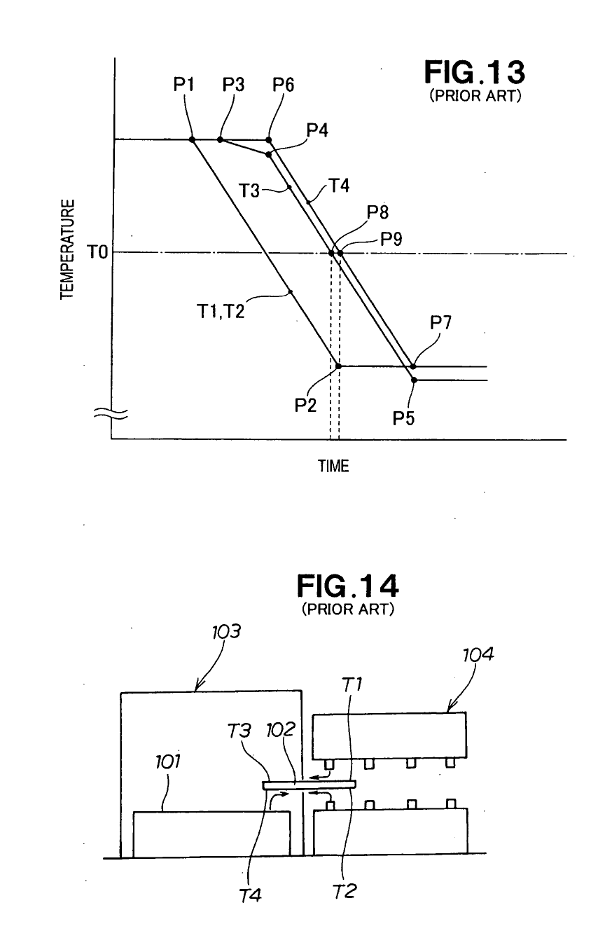

Next, a single-curved glass sheet manufacturing apparatus according to a second embodiment of the present invention will be described with reference to FIGS. 9(a) to (b).

A cooling device 43 is provided with a plurality of swing nozzles 45 swingably provided to an upper wind box 44 and in which the blowing direction of cooling air can be switched, as shown in FIG. 9(a).

The glass sheet 12 is transported, and when the glass sheet 12 arrives at the glass sheet position detection means 32, the controller 31 causes the swing nozzles 45 to swing facing downstream, as shown in FIG. 9(b). When made to swing, the swing nozzles 45 blow cooling air downstream a distance L3. The timing for directly spraying cooling air onto the upper surface of the glass sheet 12 can thereby be delayed.

The swing nozzles 45 are made to swing in the forward direction of the glass sheet 12 when the rear end upper surface T7 and the rear end lower surface T8 are transported into the cooling device 43. It is possible to keep cooling air from making contact with the rear end upper surface T7 of the glass sheet 12 while cooling air is brought into contact with the rear end lower surface T8 of the glass sheet 12. The rear end lower surface T8 is rapidly cooled and the cooling air is also brought into direct contact with the rear end upper surface T7 at a timing in which the rear end lower surface T8 reaches the same temperature as the rear end upper surface T7. The temperatures of the rear end upper surface T7 and the rear end lower surface T8 can thereby reach the strain point T0 at substantially the same timing. Since the temperatures of front end upper surface T5 and the front end lower surface T6 already reach the strain point T0 at substantially the same timing, the difference in the radius of curvature of the front end of the glass sheet and the radius of curvature of the rear end is reduced.

In the above-described embodiments, the single-curved glass sheet was described in relation to a vehicle window glass sheet as an example but can be used without limitation thereto in applications involving a building window glass sheet or the like.

Obviously, various minor changes and modifications of the present invention are possible in light of the above teaching. It is therefore to be understood that within the scope of the appended claims the invention may be practiced otherwise than as specifically described.

What is claimed is:

1. A single-curved glass sheet manufacturing apparatus comprising:
a heating furnace for heating a glass sheet on a heating bed therein to transform the glass sheet into an arbitrary shape; and
a cooling device, provided adjacent to the heating furnace, for cooling the glass sheet by bringing cooling air into contact with the glass sheet transformed in the heating furnace,
wherein the cooling device comprises:
a plurality of lower nozzles for spraying cooling air onto a lower surface of the glass sheet;
glass sheet position detection means, disposed above the lower nozzles, for detecting a position of the glass sheet;
a plurality of upper nozzles, disposed above the glass sheet position detection means, for spraying the cooling air onto an upper surface of the glass sheet; and
movement means, connected to the upper nozzles, for moving the upper nozzles parallel to a direction of movement of the glass sheet.

2. A single-curved glass sheet manufacturing apparatus comprising:
a heating furnace for heating a glass sheet on a heating bed thereof to transform the glass sheet into an arbitrary shape; and
a cooling device, provided adjacent to the heating furnace, for cooling the glass sheet by bringing cooling air into contact with the glass sheet transformed in the heating furnace,
wherein the cooling device comprises:
a plurality of lower nozzles for blowing cooling air onto a lower surface of the glass sheet;
glass sheet position detection means, disposed above the lower nozzles, for detecting a position of the glass sheet;
an upper wind box, provided above the glass sheet position detection means, for reserving the cooling air;
a plurality of swing nozzles provided to the upper wind box in such a manner as to be swingable in a direction of movement of the glass sheet; and
a controller for switching directions of delivery of the cooling air by causing the swing nozzles to swing in the direction of movement of the glass sheet.

3. A single-curved glass sheet manufacturing method comprising the steps of:
heat-shaping a glass sheet into a predetermined single-curved shape; and
cooling the heat-shaped glass sheet by applying cooling air thereto,
wherein the cooling step comprises:
causing the glass sheet to continuously move forward along a path of movement within a cooling device;
cooling a front end upper surface and a front end lower surface of the glass sheet simultaneously;
then, cooling a rear end lower surface of the glass sheet; and
a predetermined time thereafter, cooling a rear end upper surface of the glass sheet.

4. A single-curved glass sheet manufactured by a single-curved glass sheet manufacturing method which comprises the steps of heat-shaping a glass sheet into a predetermined single-curved shape; and cooling the heat-shaped glass sheet by applying cooling air thereto, the cooling step comprising: causing the glass sheet to continuously move forward along a path of movement within a cooling device; cooling a front end upper surface and a front end lower surface of the glass sheet simultaneously; then, cooling a rear end lower surface of the glass sheet; and a predetermined time thereafter, cooling a rear end upper surface of the glass sheet,
wherein the single-curved glass sheet has a front end part of a first radius of curvature and a rear end part of a second radius of curvature, a difference between the first radius of curvature and the second radius of curvature being set to be 50 mm or less, and the glass sheet also has a length along the path of movement, which is set to be 800 mm or more.
